(19) United States
(12) Patent Application Publication
(10) Pub. No.: US 2009/0122890 A1
(43) Pub. Date: May 14, 2009

(54) OFDM DCM DEMODULATION METHOD

(75) Inventor: Mau-Lin Wu, Hsinchu City (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 11/937,007

(22) Filed: Nov. 8, 2007

(51) Int. Cl. H04L 23/02

(52) U.S. Cl. 375/261

(57) ABSTRACT

An OFDM DCM demodulation method is provided. The OFDM DCM demodulation method mainly includes the following steps. First, calculate a log likelihood of a first demodulation mode. Then calculate a log likelihood of a second demodulation mode. Finally, calculate a demodulation output according to the log likelihoods of the first demodulation mode and the second demodulation mode. The demodulation output may serve as an output of a demodulator of a receiving end of a DCM communication system.

### BACKGROUND OF THE INVENTION

1. Field of the Invention

The present invention generally relates to an orthogonal frequency-division multiplexing (OFDM) dual carrier modulation (DCM), and particularly, to a demodulation method for an OFDM DCM.

2. Description of Related Art

OFDM technologies become popular in recent years. For example, in the short distance wireless communication field, there is set a standard for ultra wideband communication based on the MultiBand OFDM (MB-OFDM) by the MultiBand OFDM Alliance (MBOA) and the WiMedia Alliance, which is also known as MB-OFDM physical Layer Specification.

FIGS. 1 and 2 are schematic diagrams of a conventional OFDM communication system, in which FIG. 1 illustrates a transmitting end, and FIG. 2 illustrates s receiving end. As shown in FIG. 1, in a transmitting end 100, a data bit 101 to be transmitted passes a scrambler 102 in which the data bit 101 is scrambled in a fixed certain way for avoiding generating a fixed data pattern. The scrambled signal then is convolutionally encoded by a convolutional encoder 103. The signal then passes an interleaver 104 for exchanging orders thereof. Then the data bit 101 is OFDM modulated by a modulator 105. Then an inverse fast Fourier transformer (IFFT) 106 converts the modulated signal from a frequency domain to a time domain. Then a transmitter filter 107 filters to remove a sideband signal outside the frequency band therefrom. A digital-to-analog converter (DAC) 108 then converts the signal into an analog signal. Then, a radio frequency unit 109 converts the analog signal from a base band to a radio band. Finally, the analog signal is amplified, and then emitted from an antenna 110.

In a receiving end 200 as shown in FIG. 2, an antenna 201 receives the signal. After being amplified by a RF unit 202, the signal is converted from radio band to a base band. Then an analog-to-digital converter 203 converts the signal from an analog signal into a digital signal. Then a receiver filter 204 filters the signal to remove adjacent channel interference, and a fast Fourier transformer 205 converts the signal from a time domain to a frequency domain. A channel estimator 206 then pre-estimates a deformation of the signal when passing a channel and generating a compensation signal. Then an equalizer 207 recovers the signal to its original form according to the compensation signal. A demodulator 208 then demodulates the signal, and a deinterleaver 209 recovers orders of the signal. A Viterbi decoder 210 encodes the convolutionally encoded signal. Finally, a descrambler 211 recovers the scrambled signal to the data bit 101.

OFDM is featured in dividing a carrier into a plurality of sub-carriers, each of which being modulated in its own band and independently transmitting individual data. Typically, an ultra wideband system often straddles over very a wide band, for example 528 MHz, or even up to 1GHz. Therefore, the received signals often fade at some certain bands. Sometimes, there may even happen deep fading, as shown in FIG. 3.

FIG. 3 illustrates a comparison between a best channel impulse response (CIR) and a worst CIR simulated from a CM4 channel model according to the 802.15.3a standard by Institute of Electrical and Electronics Engineers (IEEE). Selected from a hundred sets of channel simulations, the best CIR 301 and the worst CIR 302 are described in FIG. 3, in which the y-axis represents a power spectral density, and the x-axis represents a frequency thereof. As illustrated in FIG. 3, the worst CIR 302 exhibits deep fading over 20 dB in frequency bands marked as 303 and 304 respectively. Such serious deep fading may cause the data can not be retrieved therefrom and drastically increase a packet error rate (PER) thereof, which destroys the total efficiency of the communication system.

In order to avoid performance degradation caused by deep fading, a typical UWB communication system usually employs a DCM technology to modulate a same data with two sub-carriers at two different frequencies. In such a way, in case one of the sub-carriers encounters a deep fading, the rest one can accomplish the transmittance of the data. According to a MB-OFDM standard.

FIGS. 4 and 5 are schematic diagrams illustrating a 16 points quadrature amplitude modulation (16QAM hereinafter) for performing a DCM operation. According to the MB-OFDM physical Layer Specification, after being convolutionally encoded and interleaved, a binary data serial b[i], wherein i=0, 1, 2, . . . , should be divided into 200-bit groups, which are converted by DCM into 100 complex numbers. When being converted, each of the 200 bit group is divided into 50 4-bit groups. Each 4-bit group can be represented as (b[g(k)],b[g(k)+1],b[g(k)+50],b[g(k)]+51), wherein k ε [0,49], and (b[g(k)],b[g(k)+1],b[g(k)+50],b[g(k)]+51),wherein k ε [0,49], and

$$g ( k ) = \{ \begin{matrix}2 k & k ∈ [ 0 , 24 ] \\ 2 k + 50 & k ∈ [ 25 , 49 ]\end{matrix}$$

Then, each of the 4-bit group is DCM modulated according to the 16QAM constellation as shown in FIGS. 4 and 5. As shown in FIGS. 4 and 5, the DCM is featured in that each 4-bit group is modulated at two sub-carriers at different frequencies by two different constellations respectively. However, the DCM 16QAM is different from ordinary standard 16QAM which is encoded by Gray code and only has one bit different between two adjacent symbols. The DCM 16QAM does not follow the Gray code.

However, there is also a risk that both of the two sub-carriers encounter deep fading which is a difficulty for the conventional 16QAM and quadrature phase-shift keying (QPSK) demodulation method.

US patent publication No. 2005/0195765 discloses to combine two different 16QAM sub-carriers into two different QPSK signals with different approaches by QPSK dividing, and then individually demodulates the them respectively. This method has an advantage of having no inter-channel interference (ICI). Therefore, it is ideal when there is no deep fading happened. However, QPSK dividing method amplify one sub-carrier having relative lower power while depressing the other one sub-carrier having relative higher power which is equivalent to making good signal worse while amplifying worse signal. As such, the QPSK dividing method is not a good solution when there is deep fading.

Further, in a thesis, named “A Technique for Demapping Dual Carrier Modulated UWB OFDM Signals with Improved Performance”, published in Vehicular Technology Conference, P. 38-42, September 2005, there is disclosed a maximum ratio combine method (MRC hereinafter). The MRC method proposes to calculate a weighting sum of powers of the two sub-carriers. The MRC method depresses the worse sub-carrier and amplifies the better one. Therefore, the MRC performs better than conventional when encountering deep fading. Unfortunately, this method cannot solve the problem of ICI, and the performance in its entirety is even worse than the QPSK dividing method.

Accordingly, it is a major concern to develop a better DCM demodulation method to solve the foregoing problems.

### SUMMARY OF THE INVENTION

Accordingly, the present invention is directed to an OFDM DCM demodulation method, for demodulating dual carrier signals of UWB OFDM communication system, which can achieve better performance no matter there is deep fading encountered or not.

The present invention further provides an OFDM DCM demodulation method. The method includes: respectively calculating log likelihoods of a first demodulation mode and a second demodulation mode, and according to which a demodulation output being calculated. The demodulation output can be an output of a receiving end of the communication system.

According to an embodiment of the invention, the first demodulation mode is a 16QAM demodulation, and the second demodulation mode is a QPSK demodulation.

According to an embodiment of the invention, the foregoing 16QAM is a 16QAM of DCM, and the log likelihood thereof calculated by the MRC. The log likelihood of the foregoing QPSK demodulation is calculated by the QPSK dividing.

According to an embodiment of the present invention, the log likelihoods of the foregoing 16QAM demodulation and the foregoing QPSK demodulation are all calculated according to a DCM matrix of

$$( \begin{matrix}b & 1 \\ 1 & - b\end{matrix} ) ,$$

wherein b is a predetermined constant, e.g., 2 or other values.

According to an embodiment of the present invention, the forgoing OFDM DCM demodulation method further includes a step of calculating a channel power ratio according to signal powers of two sub-carriers of the DCM, and calculating the demodulation output according to the channel power ratio.

According to an embodiment of the present invention, the forgoing OFDM DCM demodulation method further includes the following steps. If the channel power ratio is greater than a first threshold value, the demodulation output is calculated according to the log likelihood of the second demodulation mode. If the channel power ratio is between the first threshold value and a second threshold value, the demodulation output is calculated according to a weighting combination of the log likelihoods of the first demodulation mode and the second demodulation mode. If the channel power ratio is smaller than the second threshold value, the demodulation output is calculated according to the log likelihood of the first demodulation mode.

The OFDM DCM demodulation method according to the present invention calculates the demodulation output according to log likelihoods of two demodulation modes, so as to be adapted for improve demodulators of the current DCM communication systems and enhancing capabilities of receiving ends of the DCM communication systems. The demodulation method according to the present invention is adapted to overcome the problem associated with deep fading, in that no matter there is deep fading encountered or not, it performs better than conventional demodulation methods.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a transmitting end of a conventional OFDM communication system.

FIG. 2 is a schematic diagram illustrating a receiving end of a conventional OFDM communication system.

FIG. 3 illustrates a signal deep fading in a conventional UWB communication system.

FIGS. 4 and 5 are schematic diagrams of conventional DCM.

FIG. 6 is a flow chart illustrating an OFDM DCM demodulation method according to an embodiment of the present invention.

FIG. 7 is schematic diagram comparing the performance of the OFDM DCM demodulation method according to an embodiment of the present invention with the performance of a conventional demodulation method.

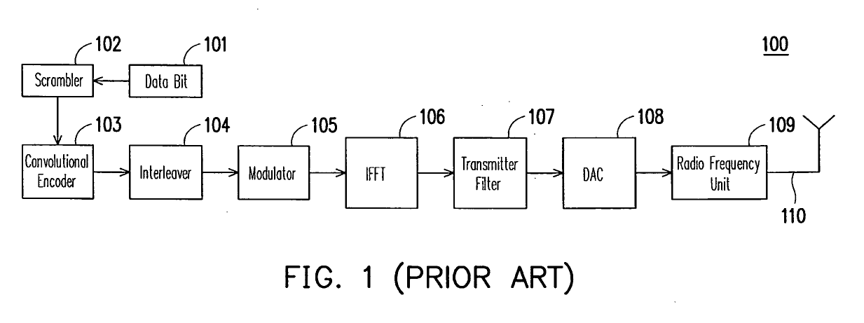

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

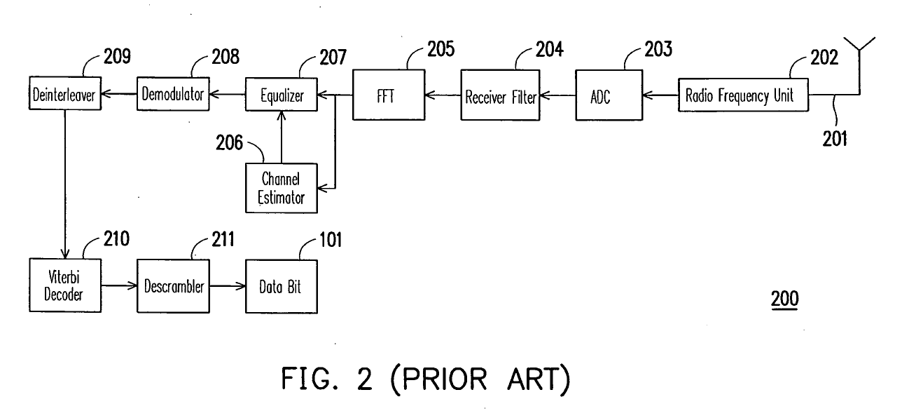

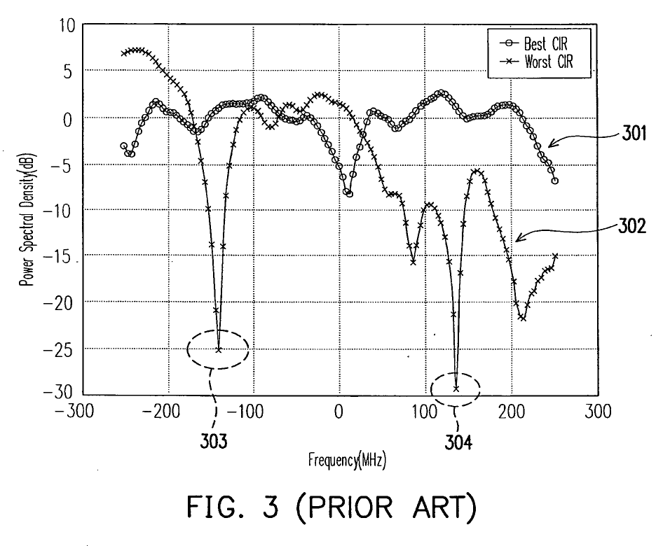

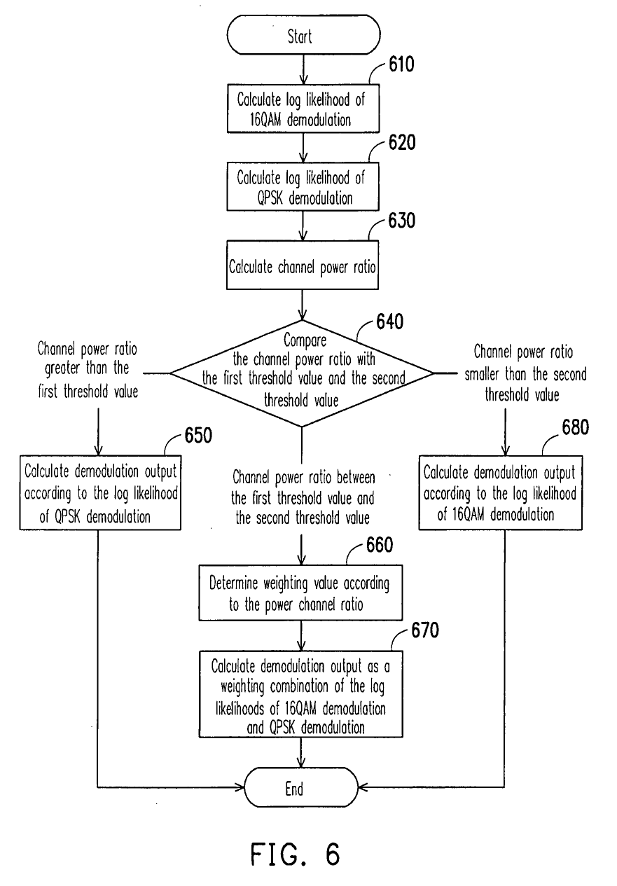

FIG. 6 is a flow chart illustrating an OFDM DCM demodulation method according to an embodiment of the present invention. The flow can be used for a demodulator of a receiving end of an OFDM system for improving the demodulator 208 as shown in FIG. 2. The steps are illustrated herebelow in details.

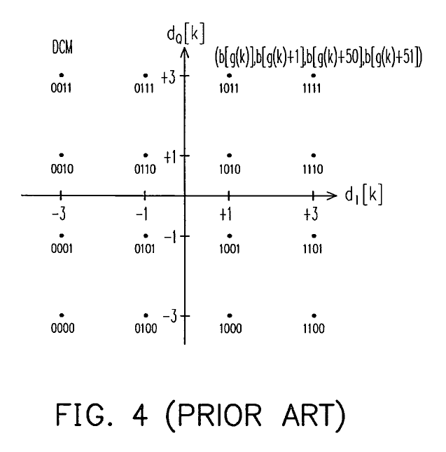

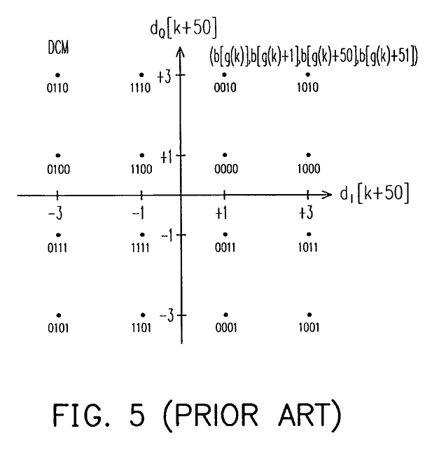

First, at step 610, a log likelihood of a 16QAM demodulation is calculated. The 16QAM demodulation is a 16QAM of DCM. The log likelihood thereof can be calculated by the MRC method, which equation is as below:

$${u}_{1 , 0 , I} ( k ) = \{ \begin{matrix}\frac{1}{\sqrt{10}} ( 2 {s}_{1 , I} ( k ) + \frac{2}{\sqrt{10}} {\vert {\hat{h}}_{1} ( k ) \vert}^{2} ) , & if {s}_{1 , I} ( k ) < - 2 {\vert {\hat{h}}_{1} ( k ) \vert}^{2} / \sqrt{10} \\ \frac{1}{\sqrt{10}} {s}_{1 , I} ( k ) , & if \begin{matrix}\frac{- 2 {\vert {\hat{h}}_{1} ( k ) \vert}^{2}}{\sqrt{10}} \leq \\ \frac{{s}_{1 , I} ( k ) < 2 {\vert {\hat{h}}_{1} ( k ) \vert}^{2}}{\sqrt{10}}\end{matrix} \\ \frac{1}{\sqrt{10}} ( 2 {s}_{1 , I} ( k ) - \frac{2}{\sqrt{10}} {\vert {\hat{h}}_{1} ( k ) \vert}^{2} ) , & if {s}_{1 , I} ( k ) \geq 2 {\vert {\hat{h}}_{1} ( k ) \vert}^{2} / \sqrt{10}\end{matrix} \\ {u}_{1 , 1 , I} ( k ) = \{ \begin{matrix}\frac{1}{\sqrt{10}} ( {s}_{1 , I} ( k ) + \frac{2}{\sqrt{10}} {\vert {\hat{h}}_{1} ( k ) \vert}^{2} ) , & if {s}_{1 , I} ( k ) < - 2 {\vert {\hat{h}}_{1} ( k ) \vert}^{2} / \sqrt{10} \\ \frac{- 1}{\sqrt{10}} {s}_{1 , I} ( k ) , & if \begin{matrix}\frac{- {\vert {\hat{h}}_{1} ( k ) \vert}^{2}}{\sqrt{10}} \leq \\ \frac{{s}_{1 , I} ( k ) < {\vert {\hat{h}}_{1} ( k ) \vert}^{2}}{\sqrt{10}}\end{matrix} \\ \frac{1}{\sqrt{10}} ( {s}_{1 , I} ( k ) - \frac{2}{\sqrt{10}} {\vert {\hat{h}}_{1} ( k ) \vert}^{2} ) , & if {s}_{1 , I} ( k ) \geq {\vert {\hat{h}}_{1} ( k ) \vert}^{2} / \sqrt{10}\end{matrix} \\ {u}_{2 , 0 , I} ( k ) = \{ \begin{matrix}\frac{1}{\sqrt{10}} ( {s}_{2 , I} ( k ) + \frac{2}{\sqrt{10}} {\vert {\hat{h}}_{2} ( k ) \vert}^{2} ) , & if {s}_{2 , I} ( k ) < - {\vert {\hat{h}}_{2} ( k ) \vert}^{2} / \sqrt{10} \\ \frac{- 1}{\sqrt{10}} {s}_{2 , I} ( k ) , & if \begin{matrix}\frac{- {\vert {\hat{h}}_{2} ( k ) \vert}^{2}}{\sqrt{10} \leq {s}_{2 , I} ( k )} < \\ \frac{{\vert {\hat{h}}_{2} ( k ) \vert}^{2}}{\sqrt{10}}\end{matrix} \\ \frac{1}{\sqrt{10}} ( {s}_{2 , I} ( k ) - \frac{2}{\sqrt{10}} {\vert {\hat{h}}_{2} ( k ) \vert}^{2} ) , & if {s}_{2 , I} ( k ) \geq {\vert {\hat{h}}_{2} ( k ) \vert}^{2} / \sqrt{10}\end{matrix} \\ {u}_{2 , 1 , I} ( k ) = \{ \begin{matrix}\frac{1}{\sqrt{10}} ( - 2 {s}_{2 , I} ( k ) - \frac{2}{\sqrt{10}} {\vert {\hat{h}}_{2} ( k ) \vert}^{2} ) , & if {s}_{2 , I} ( k ) < - 2 {\vert {\hat{h}}_{2} ( k ) \vert}^{2} / \sqrt{10} \\ \frac{- 1}{\sqrt{10}} {s}_{2 , I} ( k ) , & if \begin{matrix}\frac{- 2 {\vert {\hat{h}}_{2} ( k ) \vert}^{2}}{\sqrt{10} \leq {s}_{2 , I} ( k )} < \\ \frac{2 {\vert {\hat{h}}_{2} ( k ) \vert}^{2}}{\sqrt{10}}\end{matrix} \\ \frac{1}{\sqrt{10}} ( - 2 {s}_{2 , I} ( k ) + \frac{2}{\sqrt{10}} {\vert {\hat{h}}_{2} ( k ) \vert}^{2} ) , & if {s}_{2 , I} ( k ) \geq 2 {\vert {\hat{h}}_{2} ( k ) \vert}^{2} / \sqrt{10}\end{matrix}$$

wherein u_{1,0,I}(k), u_{1,0,I}(k), u_{2,0,I}(k), and u_{2,1,I}(k) are log likelihoods of the 16QAM MRC; s_{1,I}(k) and s_{2,I}(k) respectively represent output signals of an equalizer at a front of the demodulator, which correspond to the two sub-carriers of the DCM; ĥ₁(k) and ĥ₂(k) represent powers of two sub-carrier signals received by a receiving end; and k ε [0,49] is a serial number of a 4-bit group, as shown in FIGS. 4 and 5.

Then, at step 620, the log likelihood of the QPSK dividing demodulation is calculated, which equation is:

$${v}_{0 , I} ( k ) = \frac{\sqrt{10} ( 2 {\vert {\hat{h}}_{2} ( k ) \vert}^{2} {s}_{1 , I} ( k ) + {\vert {\hat{h}}_{1} ( k ) \vert}^{2} {s}_{2 , I} ( k ) )}{{\vert {\hat{h}}_{1} ( k ) \vert}^{2} + 4 {\vert {\hat{h}}_{2} ( k ) \vert}^{2}}$$

$${v}_{1 , I} ( k ) = \frac{\sqrt{10} ( 2 {\vert {\hat{h}}_{2} ( k ) \vert}^{2} {s}_{1 , I} ( k ) - 2 {\vert {\hat{h}}_{1} ( k ) \vert}^{2} {s}_{2 , I} ( k ) )}{4 {\vert {\hat{h}}_{1} ( k ) \vert}^{2} + {\vert {\hat{h}}_{2} ( k ) \vert}^{2}} ,$$

wherein v_{0,I}(k) and v_{1,I}(k) are log likelihoods of the QPSK dividing demodulation. It should be noted that above given are log likelihood equations of the real parts, and the imaginary parts of which can be obtained according to the real part equations and are not to be iterated hereby.

Then at step 630, the channel power ratio hᵣ is calculated, which equation is:

$${h}_{r} ( k ) = \{ \begin{matrix}{\hat{h}}_{2} ( k ) / {\hat{h}}_{1} ( k ) , & if {\hat{h}}_{2} ( k ) \leq {\hat{h}}_{1} ( k ) \\ {\hat{h}}_{1} ( k ) / {\hat{h}}_{2} ( k ) , & if {\hat{h}}_{1} ( k ) < {\hat{h}}_{2} ( k ) ,\end{matrix}$$

The above equation shows that the channel power ratio hᵣ is the smaller one of the signal powers of the two sub-carriers divided by the larger one, which represents the difference between the channel powers of the two sub-carriers received by the receiving end.

Then a demodulation output is calculated according to a comparison of the channel power ration with the two thresholds. Different equations are selected according to the result of the comparison. The demodulation method according to FIG. 6 is adapted for demodulator of a receiving end of the communication system, and the aforementioned demodulation output is the output signal of the demodulator.

After calculating the channel power ratio, the channel power ratio is compared with the first threshold value, and the second threshold value at step 640. If the channel power ration is greater than the first threshold value, then at step 650, the demodulation output is calculated according to the log likelihood of the QPSK dividing demodulation. If the channel power ration is between the first threshold value and the second threshold value, then at step 660, weighting values are determined according to the channel power ratio, and at step 670, the demodulation output is calculated according to a weighting combination of the log likelihoods of the 16QAM MRC demodulation mode and the QPSK demodulation mode. According to an aspect of the embodiment, the weighting value of the weighting combination is 1−hᵣ, and does not need to be calculated. After being compared at the step 640, if the channel power ration is smaller than the first threshold value, then at step 680, the demodulation output is calculated according to the log likelihood of the 16QAM MRC dividing demodulation. The calculation equations thereof are as follows, wherein \hat{x}_{1,I}, \hat{x}_{2,I}, \hat{X}_{1,Q}, and \hat{X}_{2,Q} represent the demodulation output, and hᵣ(k) represents the channel power ratio, and Th1 and Th2 represent the first threshold value and the second threshold value respectively.

$${\hat{x}}_{1 , I} = \{ \begin{matrix}{v}_{0 , I} ( k ) , & if {h}_{r} ( k ) \geq Th 1 \\ ( 1 - {h}_{r} ( k ) ) [ {u}_{1 , 0 , I} ( k ) + {u}_{2 , 0 , I} ( k ) ] + {v}_{0 , I} ( k ) , & if Th 2 \leq {h}_{r} ( k ) < Th 1 \\ {u}_{1 , 0 , I} ( k ) + {u}_{2 , 0 , I} ( k ) , & if {h}_{r} ( k ) < Th 2\end{matrix} \\ {\hat{x}}_{2 , I} = \{ \begin{matrix}{v}_{1 , I} ( k ) , & if {h}_{r} ( k ) \geq Th 1 \\ ( 1 - {h}_{r} ( k ) ) [ {u}_{1 , 1 , I} ( k ) + {u}_{2 , 1 , I} ( k ) ] + {v}_{1 , I} ( k ) , & if Th 2 \leq {h}_{r} ( k ) < Th 1 \\ {u}_{1 , 1 , I} ( k ) + {u}_{2 , 1 , I} ( k ) , & if {h}_{r} ( k ) < Th 2\end{matrix} \\ {\hat{x}}_{1 , Q} = \{ \begin{matrix}{v}_{0 , Q} ( k ) , & if {h}_{r} ( k ) \geq Th 1 \\ ( 1 - {h}_{r} ( k ) ) [ {u}_{1 , 0 , Q} ( k ) + {u}_{2 , 0 , Q} ( k ) ] + {v}_{0 , Q} ( k ) , & if Th 2 \leq {h}_{r} ( k ) < Th 1 \\ {u}_{1 , 0 , Q} ( k ) + {u}_{2 , 0 , Q} ( k ) , & if {h}_{r} ( k ) < Th 2\end{matrix} \\ {\hat{x}}_{2 , Q} = \{ \begin{matrix}{v}_{1 , Q} ( k ) , & if {h}_{r} ( k ) \geq Th 1 \\ ( 1 - {h}_{r} ( k ) ) [ {u}_{1 , 1 , Q} ( k ) + {u}_{2 , 1 , Q} ( k ) ] + {v}_{1 , Q} ( k ) , & if Th 2 \leq {h}_{r} ( k ) < Th 1 \\ {u}_{1 , 1 , Q} ( k ) + {u}_{2 , 1 , Q} ( k ) , & if {h}_{r} ( k ) < Th 2.\end{matrix}$$

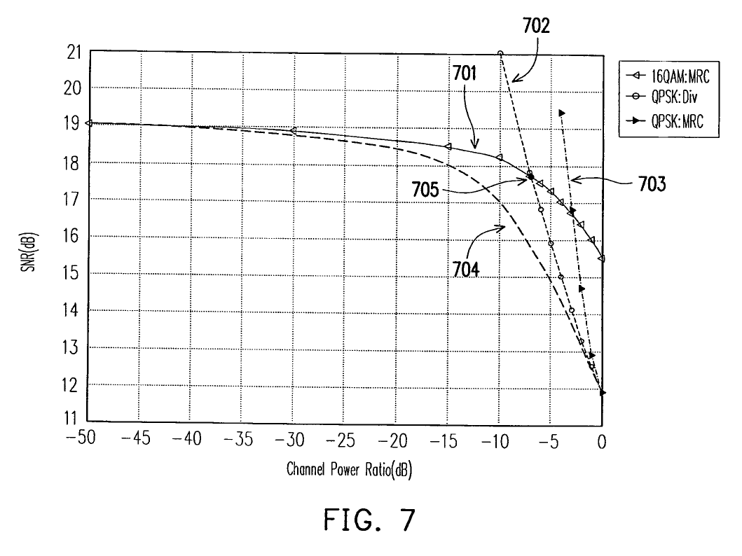

FIG. 7 is schematic diagram comparing a performance of the OFDM DCM demodulation method according to an embodiment of the present invention with the conventional demodulation method, which is obtained by a mathematical analysis and mathematical simulation software. The x-axis represents the channel power ratio hr, in which a position more adjacent to left side represents a more serious signal fading of a sub-carrier. The y-axis represents a signal-to-noise ratio (SNR) corresponding to an 8% packet error rate (PER) of the demodulation output, in which a lower SNR is more desirable. Curves 701 through 704 are SNR curves of the conventional 16QAM MRC demodulation method, the conventional QPSK dividing method, the conventional QPSK MRC demodulation method, and the demodulation method according to the embodiment of the present invention, respectively.

FIG. 7 shows that the demodulation method according to the embodiment of the present invention is featured in adjusting with the two threshold values Th1 and Th2, so as to take advantages of both the 16QAM MRC and QPSK dividing methods. According to an aspect of the embodiment, Th1 and Th2 are set at two sides of the cross-section point 705 of the SNR curves 701 and 702. In other words, Th1 is set at the right side of the cross-section point 705, and Th2 is set at the left side of the cross-section point 705. The cross-section point 705 corresponds to a specific channel power ratio, under which the 16QAM MRC demodulation method and the QPSK dividing correspond to a same SNR.

As shown in FIG. 7, the conventional QPSK dividing method performs well when there is no signal fading happens. However, when one of the two sub-carriers encounters a deep fading, the SNR thereof drastically increases, and the performance thereof becomes bad. In another hand, although the conventional 16QAM MRC demodulation method does not perform as good as the QPSK dividing method when there is no signal fading happens, no matter how serious the signal fading of the one of the two sub-carriers is, the SNR thereof would converge within a certain range and would not be out of control. The demodulation method according to the embodiment of the present invention takes advantages of adjustment by two threshold values, in that the optimal QPSK dividing is employed when there is no signal fading happens, and in a intermediate scale, a weighting combination of the QPSK dividing and the 16QAM MRC demodulation method is employed so as to take advantages of both these two demodulation methods and thus accomplishing an optimal performance in its entirety.

In the process described in FIG. 6 and the corresponding equations, the log likelihoods of the 16QAM MRC demodulation and the QPSK dividing demodulation are calculated according to the DCM matrix of

$$( \begin{matrix}2 & 1 \\ 1 & - 2\end{matrix} ) .$$

However, it should be noted that the present invention can be extended to a DCM matrix of

$$( \begin{matrix}b & 1 \\ 1 & - b\end{matrix} ) ,$$

wherein b is a predetermined constant other than 2. When the DCM matrix of

$$( \begin{matrix}b & 1 \\ 1 & - b\end{matrix} )$$

is adopted, the log likelihood equation of the 16QAM MRC demodulation at the step 610 and the log likelihood equation of the QPSK dividing demodulation should be modified as follows:

$${K}_{D} = \frac{1}{\sqrt{2 ( 1 + {b}^{2} )}}$$

$${u}_{1 , 0 , I} ( k ) = \{ \begin{matrix}{K}_{D} ( b {s}_{1 , I} ( k ) + b {K}_{D} {\vert {\hat{h}}_{1} ( k ) \vert}^{2} ) , & if {s}_{1 , I} ( k ) < - 2 {K}_{D} {\vert {\hat{h}}_{1} ( k ) \vert}^{2} \\ {K}_{D} {s}_{1 , I} ( k ) , & if - 2 {K}_{D} {\vert {\hat{h}}_{1} ( k ) \vert}^{2} \leq {s}_{1 , I} ( k ) < 2 {K}_{D} {\vert {\hat{h}}_{1} ( k ) \vert}^{2} \\ {K}_{D} ( b {s}_{1 , I} ( k ) - b {K}_{D} {\vert {\hat{h}}_{1} ( k ) \vert}^{2} ) , & if {s}_{1 , I} ( k ) \geq - 2 {K}_{D} {\vert {\hat{h}}_{1} ( k ) \vert}^{2}\end{matrix} \\ {u}_{1 , 1 , I} ( k ) = \{ \begin{matrix}{K}_{D} ( {s}_{1 , I} ( k ) + b {K}_{D} {\vert {\hat{h}}_{1} ( k ) \vert}^{2} ) , & if {s}_{1 , I} ( k ) < - {K}_{D} {\vert {\hat{h}}_{1} ( k ) \vert}^{2} \\ - {K}_{D} {s}_{1 , I} ( k ) , & if - {K}_{D} {\vert {\hat{h}}_{1} ( k ) \vert}^{2} \leq {s}_{1 , I} ( k ) < {K}_{D} {\vert {\hat{h}}_{1} ( k ) \vert}^{2} \\ {K}_{D} ( {s}_{1 , I} ( k ) - b {K}_{D} {\vert {\hat{h}}_{1} ( k ) \vert}^{2} ) , & if {s}_{1 , I} ( k ) \geq {K}_{D} {\vert {\hat{h}}_{1} ( k ) \vert}^{2}\end{matrix} \\ {u}_{2 , 0 , I} ( k ) = \{ \begin{matrix}{K}_{D} ( {s}_{2 , I} ( k ) + b {K}_{D} {\vert {\hat{h}}_{2} ( k ) \vert}^{2} ) , & if {s}_{2 , I} ( k ) < - {K}_{D} {\vert {\hat{h}}_{2} ( k ) \vert}^{2} \\ - {K}_{D} {s}_{2 , I} ( k ) , & if - {K}_{D} {\vert {\hat{2}}_{1} ( k ) \vert}^{2} \leq {s}_{2 , I} ( k ) < {K}_{D} {\vert {\hat{h}}_{2} ( k ) \vert}^{2} \\ {K}_{D} ( {s}_{2 , I} ( k ) - b {K}_{D} {\vert {\hat{h}}_{2} ( k ) \vert}^{2} ) , & if {s}_{2 , I} ( k ) \geq {K}_{D} {\vert {\hat{h}}_{2} ( k ) \vert}^{2}\end{matrix} \\ {u}_{2 , 1 , I} ( k ) = \{ \begin{matrix}{K}_{D} ( - b {s}_{2 , I} ( k ) - b {K}_{D} {\vert {\hat{h}}_{2} ( k ) \vert}^{2} ) , & if {s}_{2 , I} ( k ) < - 2 {K}_{D} {\vert {\hat{h}}_{2} ( k ) \vert}^{2} \\ - {K}_{D} {s}_{2 , I} ( k ) , & if - 2 {K}_{D} {\vert {\hat{h}}_{2} ( k ) \vert}^{2} \leq {s}_{2 , I} ( k ) < 2 {K}_{D} {\vert {\hat{h}}_{2} ( k ) \vert}^{2} \\ {K}_{D} ( - b {s}_{2 , I} ( k ) + b {K}_{D} {\vert {\hat{h}}_{2} ( k ) \vert}^{2} ) , & if {s}_{2 , I} ( k ) \geq 2 {K}_{D} {\vert {\hat{h}}_{2} ( k ) \vert}^{2}\end{matrix}$$

When the DCM matrix of

$$( \begin{matrix}2 & 1 \\ 1 & - 2\end{matrix} )$$

is used, the 16QAM according to the present invention is a conventional 16QAM having an evenly distributed constellation. When the DCM matrix of

$$( \begin{matrix}b & 1 \\ 1 & - b\end{matrix} )$$

is used, the 16QAM according to the present invention is a non-conventional 16QAM having an unevenly distributed constellation which can also be named as a generalized 16QAM.

Besides the 16QAM and the QPSK, other demodulation modes corresponding to DCM can also be adopted according to the spirit of the present invention, in which a log likelihood thereof can be calculated for calculating the demodulation output. For example, in other embodiments of the present invention, the DCM of the transmitting end uses a 64 points quadrature amplitude modulation (64QAM), the receiving end is also required to use a 64QAM instead of the 16QAM for calculating the demodulation output.

In summary, the OFDM DCM demodulation method according to the present invention calculates a demodulation output according to log likelihoods of two demodulation modes, which is adapted for improving demodulators of the conventional DCM communication systems and improving capabilities of receiving ends of the DCM communication systems. The demodulation method according to the present invention performs better than the conventional demodulation methods, no matter there is deep fading happened or not.

Further, because the demodulation method according to the present invention improves capabilities of the demodulators, effective bits required by the deinterleaver and the Viterbi decoder at a rear of the demodulator, so as to reduce the required gate count of the deinterleaver and the Viterbi decoder. The gate count of the deinterleaver and the Viterbi decoder weights much in the entire receiving end, and therefore the demodulation method according to the present invention is adapted for reduce production cost of the receiving end of the entire communication system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An OFDM DCM demodulation method, comprising:
calculating a log likelihood of a first demodulation mode;
calculating a log likelihood of a second demodulation mode; and
calculating a demodulation output according to the log likelihoods of the first demodulation mode and the second demodulation mode.

2. The OFDM DCM demodulation method according to claim 1, wherein each of the first demodulation mode and the second demodulation mode is a DCM demodulation mode.

3. The OFDM DCM demodulation method according to claim 2, wherein the first demodulation mode is a 16QAM demodulation and the second demodulation mode is a QPSK demodulation.

4. The OFDM DCM demodulation method according to claim 3, wherein the 16QAM is a DCM 16QAM.

5. The OFDM DCM demodulation method according to claim 3, wherein the log likelihood of the 16QAM demodulation is calculated by a maximum ratio combine method (MRC).

6. The OFDM DCM demodulation method according to claim 3, wherein the log likelihood of the QPSK demodulation is calculated by a QPSK dividing method.

7. The OFDM DCM demodulation method according to claim 3, wherein the log likelihoods of the 16QAM demodulation and the QPSK demodulation are all calculated according to a DCM matrix of
$$( \begin{matrix}b & 1 \\ 1 & - b\end{matrix} ) ,$$
wherein b is a predetermined constant.

8. The OFDM DCM demodulation method according to claim 7, wherein b is equal to 2.

9. The OFDM DCM demodulation method according to claim 1, wherein the OFDM DCM demodulation method is conducted by a demodulator of a receiving end of an OFDM communication system.

10. The OFDM DCM demodulation method according to claim 9, wherein the log likelihoods of the first demodulation mode and the second demodulation mode are all calculated according to an output signal of an equalizer of the receiving end.

11. The OFDM DCM demodulation method according to claim 9, wherein the log likelihoods of the first demodulation mode and the second demodulation mode are all calculated according to signal powers of two sub-carriers of the DCM received by the receiving end.

12. The OFDM DCM demodulation method according to claim 11, further comprising:
calculating a channel power ratio according to the signal powers of the two sub-carriers; and
calculating the demodulation output according to the channel power ratio.

13. The OFDM DCM demodulation method according to claim 12, wherein the channel power ratio is equal to the smaller one of the signal powers of the two sub-carriers divided by the larger one.

14. The OFDM DCM demodulation method according to claim 12, further comprising:
calculating the demodulation output according to a comparison of the channel power ratio with a first threshold value, and a comparison of the channel power ratio with a second threshold value.

15. The OFDM DCM demodulation method according to claim 14, wherein there is a specific channel power ratio between the first threshold value and the second threshold value, under which a SNR required by the first demodulation mode for achieving a specific packet error rate (PER) is equal to a SNR required by the second demodulation mode for achieving the specific PER.

16. The OFDM DCM demodulation method according to claim 14, further comprising:
if the channel power ratio is greater than the first threshold value, calculating the demodulation output according to the log likelihood of the second demodulation mode;
if the channel power ratio is between the first threshold value and the second threshold value, calculating the demodulation output according to a combination of the log likelihoods of the first demodulation mode and the second demodulation mode; and
if the channel power ratio is smaller than the second threshold value, calculating the demodulation output according to the log likelihood of the first demodulation mode.

17. The OFDM DCM demodulation method according to claim 16, wherein the combination of the log likelihoods of the first demodulation mode and the second demodulation mode is a weighting combination.

18. The OFDM DCM demodulation method according to claim 17, wherein a weighting value of the weighting combination is determined according to the channel power ratio.
